(19) United States
(12) Patent Application Publication
(10) Pub. No.: US 2003/0059203 A1
(43) Pub. Date: Mar. 27, 2003

(54) Apparatus and method for recording and reproducing a digital brodcast

(76) Inventor: Michihiro Fukushima, Fuchu-shi (JP)

Correspondence Address: PILLSBURY WINTHROP, LLP, P.O. BOX 10500, MCLEAN, VA, 22102, US

(21) Appl. No.: 10/217,630

(22) Filed: Aug. 14, 2002

(30) Foreign Application Priority Data
Sep. 27, 2001 (JP) 2001-297045

(51) Int. Cl. H04N 5/76; G06F 3/00; G06F 13/00

(52) U.S. Cl. 386/83; 725/58

(57) ABSTRACT

A digital broadcast is received to obtain its contents. The contents are recorded on a recording medium in a state that time-of-day information generated from a time-of-day information managing section driven by a power supply is attached to the contents. Whether or not reproduction of the contents read out from the recording medium is permitted is determined based on the time-of-day information attached to the contents read out from the recording medium and the time-of-day information generated at the time-of-day information managing section.

### CROSS-REFERENCE TO RELATED APPLICATIONS

This application is based upon and claims the benefit of priority from the prior Japanese Patent Application No. 2001-297045, filed Sep. 27, 2001, the entire contents of which are incorporated herein by reference.

### BACKGROUND OF THE INVENTION

1. Field of the Invention

The present invention relates to a receiving system for receiving a digital broadcast and, in particular, to an improvement in an apparatus and method for recording and reproducing received contents onto and from a large-capacity recording medium, such as a hard disk.

2. Description of the Related Art

In recent times, as is well known in this field, a digital broadcast recording/reproducing apparatus with a hard disk drive (HDD) incorporated therein has been developed with the advance of digital data processing techniques and with a current tendency toward a greater capacity, lower cost, etc., of hard disks.

This HDD-incorporated digital broadcast recording/reproducing apparatus can receive a digital broadcast, convert its contents into predetermined data streams and record/reproduce them onto/from the hard disk.

According to this kind of digital broadcast recording/reproducing apparatus, it is possible to record contents now on the air onto the hard disk in real time and realize time shift reproduction, such as viewing the recorded contents later.

In the digital broadcast, it is possible to impose a “viewing restriction” on specified contents so that the time shift reproduction can be made for a predetermined time only.

In the case where such a “viewing restriction” is imposed on the contents, broadcasting is made on the broadcast side with its corresponding viewing restriction information attached to the contents to be broadcast. Then, on the digital broadcast recording/reproducing apparatus side, the received contents are recorded on the hard disk with its current time-of-day information attached thereto.

After this, upon reading out the contents from the hard disk in the digital broadcast recording/reproducing apparatus, the apparatus compares the attached time-of-day information with the current time-of-day, refers the result of comparison to a restriction time initially set therein and determines whether or not the time shift reproduction is permitted. By doing so, the above-mentioned “viewing restriction” is realized.

Here, on the digital broadcast, in order to make time-of-day management on a receiver side, a time-of-day/date table TDT including date and time-of-day information and a time-of-day/date offset table TOT are defined in service information (SI) described in an ARIB (Association of Radio Industries and Businesses) STD-B10.

The time-of-day information TDT and TOT may be transmitted once for 30 seconds and used for synchronization with an internal clock in the receiver. In a BS (Broadcasting Satellite) digital broadcast, for example, these have been actually employed for synchronization with the internal clock.

For this reason, the digital broadcast recording/reproducing apparatus is so configured that, upon the reception of a “viewing-restricted” contents, it prepares current time-of-day information based on the above-mentioned time-of-day information TDT and TOT and records resultant time-of-day information in the hard disk in a way to be attached to the contents.

After this, the digital broadcast recording/reproducing apparatus compares the time-of-day information in the contents which is read out from the hard disk with the current time-of-day information prepared according to the received time-of-day information TDT, TOT and calculates out an elapsed time to a present time from a time point at which the contents were recorded on the hard disk.

And the digital broadcast recording/reproducing apparatus determines whether or not the calculated elapsed time exceeds the restriction time initially set for the apparatus and determines whether or not the time shift reproduction is permitted.

For the above-mentioned digital broadcast recording/reproducing apparatus it becomes impossible to prepare correct time-of-day information if the time-of-day information TDT and TOT are not obtained, for example, due to poor reception, etc.

Even if, therefore, a time involved is within a normal restriction time in which the time shift reproduction is permitted, it is impossible to effect a time shift reproduction of the contents or it is possible to do so even if the restriction time in which the time shift reproduction is permitted has elapsed, so that the problem arises that no correct “viewing restriction” is effected for the time shift reproduction.

### BRIEF SUMMARY OF THE INVENTION

It is accordingly the object of the present invention to provide a digital broadcast recording/reproducing apparatus and method which can be realized with the above in view.

According to one aspect of the present invention, there is provided a digital broadcast recording/reproducing apparatus comprising a receiving section configured to receive a digital broadcast and obtain its contents; a time information managing section driven by being supplied with a power source and configured to generate time information; a recording section configured to record the contents which are obtained at the receiving section onto a recording medium, the contents being recorded with the time information attached thereto; and a reproduction determining section configured to determine, based on the time information attached to the contents read out from the recording medium and the time information generated from the time information managing section, whether or not reproduction of the contents read out from the recording medium is permitted.

According to another aspect of the present invention, there is provided a digital broadcast recording/reproducing method comprising receiving a digital broadcast and obtaining its contents; generating time information by being supplied with a power source; recording the obtained contents onto a recording medium with the generated time information attached to the contents; and, based on the time information attached to the contents read out from the recording medium and the generated time information, determining whether or not reproduction of the contents read out from the recording medium is permitted.

### BRIEF DESCRIPTION OF THE SEVERAL VIEWS OF THE DRAWING

FIG. 1 is a block diagram for explaining a digital broadcast recording/reproducing apparatus according to one embodiment of the present invention;

FIG. 2 is a flowchart for explaining an operation involved when contents received in the embodiment are recorded on a hard disk;

FIG. 3 is a flowchart for explaining an operation involved when time-of-day information obtained from a time-of-day information managing circuit in the embodiment is unlawful; and

FIG. 4 is a flowchart for explaining an operation involved when the contents are time shift reproduced from a hard disk in the embodiment.

### DETAILED DESCRIPTION OF THE INVENTION

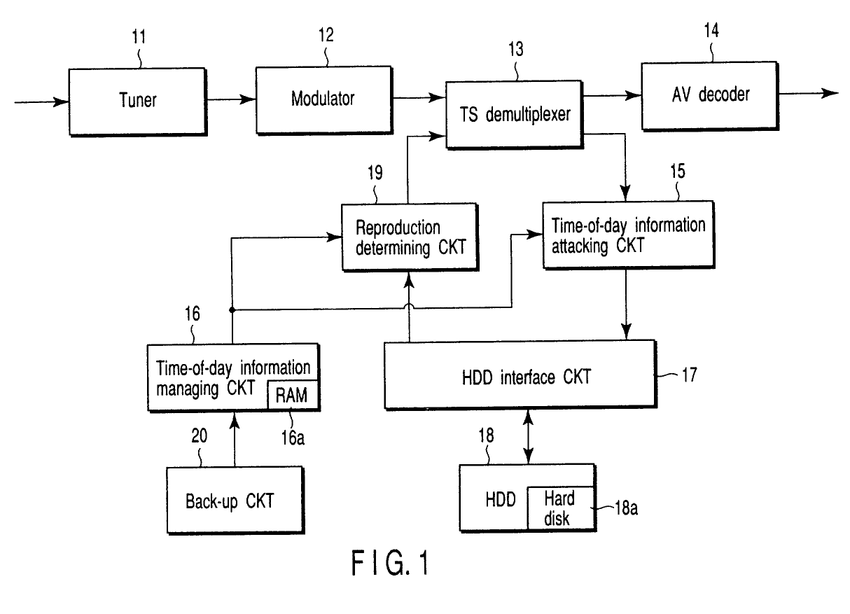

One embodiment of the present invention will be described below with reference to the accompanying drawing. FIG. 1 shows a digital broadcast recording/reproducing apparatus explained in conjunction with this embodiment. In FIG. 1, a received digital broadcast signal is supplied to a tuner 11 where desired contents are extracted.

The contents extracted by the tuner 11 are supplied to a demodulator 12 where they are demodulated into a transport stream (TS). The stream signal of the demodulator 12 is supplied to a TS demultiplexer 13 where it is separated into an audio stream, video stream and SI information.

Of these, the audio stream and video stream are supplied to an AV (Audio Video) decoder 14 where these are decoded as an audio signal and a video signal. Further, the SI information is processed by an MPU (Micro Processing Unit), not shown, and used for an EPG (Electronic Program Guide), channel selection processing, etc.

Here, an explanation will be made about recording and reproducing contents on which a “viewing restriction” is imposed for time shift reproduction. That is, the streams (contents) to be recorded are separated by means of the TS demultiplexer 13.

The contents separated by the TS demultiplexer 13 are supplied to a time-of-day information attaching circuit 15 where current time-of-day information managed by a time-of-day information managing circuit 16 is attached to the streams.

The contents with the time-of-day information attached thereto by the time-of-day information attaching circuit 15 are supplied via an HDD interface circuit 17 to an HDD 18 where the contents are recorded on a hard disk 18a.

It is to be noted that the time-of-day may be attached to the streams, for example, at each transport unit or at each unit of recording onto the hard disk 18a or may be retained in a separate file associated with each picture unit of the streams.

Now, an explanation will be made below about the reproduction. The contents recorded on the hard disk 18a as set out above are read out by the HDD 18 and supplied via the HDD interface circuit 17 to a reproduction determining circuit 19.

The reproduction determining circuit 19 extracts the time-of-day information attached to, or associated with, the input contents, compares it with current time-of-day information obtained from the time-of-day information managing circuit 16 and calculates the elapsed time to the present time from the time point at which the contents are recorded on the hard disk 18a.

After this, the reproduction determining circuit 19 compares a calculated elapsed time with a “viewing restriction” time initially set for the digital broadcast recording/reproducing apparatus and, if the elapsed time exceeds the viewing restriction time, determines that the reproduction of its contents is impossible, and discards the contents under control.

If, on the other hand, the calculated elapsed time does not exceed the viewing restriction time, the reproduction determining circuit 19 determines the reproduction of the contents as being possible and supplies the input contents to the TS demultiplexer 13, so that, through the same processing as an ordinary processing action, the AV decoder 14 delivers outputs as an audio signal and video signal.

Here, as the above-mentioned viewing restriction time, a time is set, for example, within a PAUSE-able time permitted to the contents recorded on the hard disk 18a or within a PAUSE-able time permitted to the contents by being set as a setting specification of the digital broadcast recording/reproducing apparatus. The set viewing restriction time is retained, for example, in the time-of-day information managing circuit 16, reproduction determining circuit 19, etc.

In the case where the time-of-day information managed by the time-of-day information managing circuit 16 is not correct upon obtaining current time-of-day information from the time-of-day information managing circuit 16, the reproduction determining circuit 19 unconditionally determines that the reproduction of the contents read out from the hard disk 18a is not permitted, provided that reproduction is permitted so long as the PAUSE-able time of the recorded contents is unlimited.

Here, the above-mentioned time-of-day information managing circuit 16 is constructed using, for example, a real time clock IC (integrated circuit), etc., and driven under the application of a power source voltage and counts time on its own to generate time-of-day information.

Further, the time-of-day information managing circuit 16 has the function of detecting that the supplied power source voltage has deviated from a normal level range capable of operating the time-of-day information managing circuit 16 normally and retaining the result of detection in an internal RAM (Random Access Memory) 16a.

And the above-mentioned reproduction determining circuit 19 determines whether or not the time-of-day information managed by the time-of-day information managing circuit 16 is correct and does so based on the result of detection retained in the internal RAM 16a of the time-of-day information managing circuit 16.

To the time-of-day information managing circuit 16, a back-up circuit 20 is connected to back up the power source voltage: The back-up circuit 20 is comprised of a battery, a capacitor, etc., and, at a time of power failure, etc., feeds electric power to the time-of-day information managing circuit 16 to allow the normal operation of the circuit 16 to be maintained.

In this case, the back-up circuit 20 has a capacity large enough to store electric power for an accurate operation of the time-of-day information managing circuit 16 to be done at least for over a time period from the recording of the contents on the hard disk 18a until the reproduction is determined as being permitted or not, that is, for over the above-mentioned PAUSE-able time.

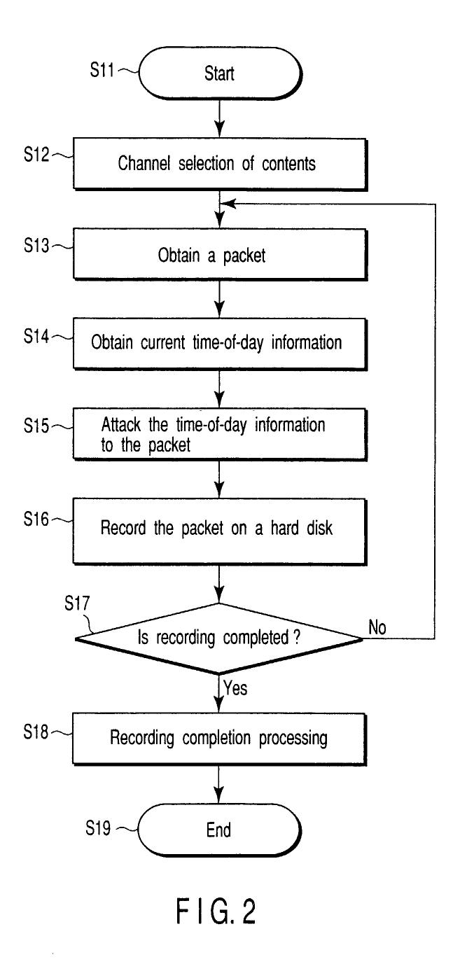

FIGS. 2, 3 and 4 are flowcharts showing the respective operations of the above-mentioned digital broadcast recording/reproduction apparatus. First, FIG. 2 shows the operation of recording the received contents on the hard disk 18a.

That is, a start operation is performed at step S11 and, at step S12, desired contents are channel-selected from a received digital broadcast signal by means of the tuner 11 and, at step S13, a packet constituting the selected contents is obtained by means of the demodulator 12.

After this, current time-of-day information is obtained from the time-of-day information managing circuit 16 by means of the time-of-day information attaching circuit 15 at step S14 and the current time-of-day information is attached to the packet at step S15 and the packet is recorded onto the hard disk 18a by means of the HDD 18 at step S16.

At step S17, it is determined whether or not the recording of the contents onto the hard disk 18a is completed. If NO, control goes back to the processing at step S13 and, if YES, the recording processing is completed at step S18 and control is ended at step S19.

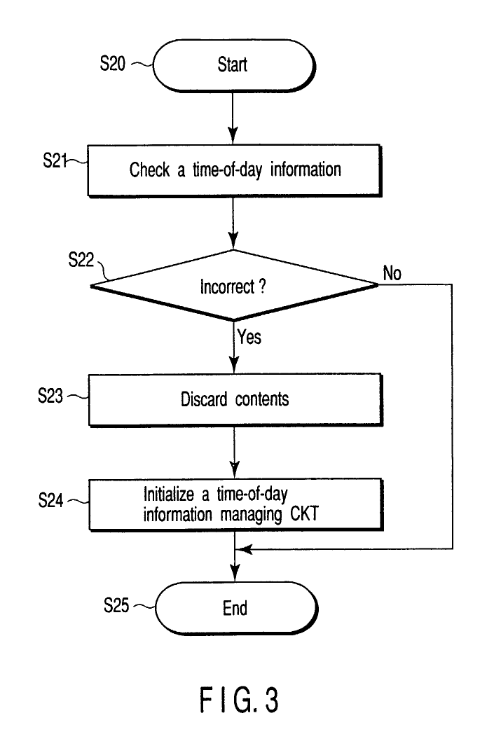

FIG. 3 shows an operation involved when the time-of-day information obtained from the time-of-day information managing circuit 16 is incorrect. That is, an operation is started at step S20 and the time-of-day information obtained from the time-of-day information managing circuit 16 is checked by the reproduction determining circuit 19 at step S21 and, at step S22, it is determined whether or not the time-of-day information is incorrect.

If NO, control is ended at step S25 and, if YES, the contents read out from the hard disk 18a are discarded by the reproduction determining circuit 19 at step S23 and, at step S24, the time-of-day information managing circuit 16 is initialized and, at step S25, control is ended.

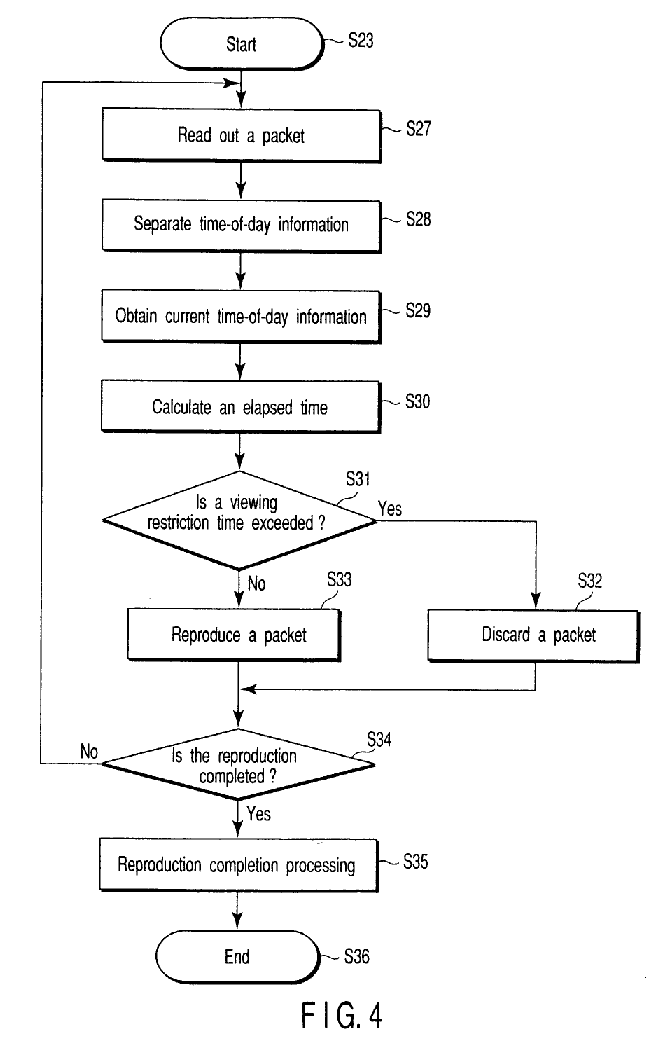

FIG. 4 shows an operation involved when the contents recorded on the hard disk 18a is time shift reproduced. That is, an operation is started at step S26 and, at step S27, a packet constituting the contents is read out by the HDD 18 from the hard disk 18a and supplied to the reproduction determining circuit 19.

Then, at step S28, the time-of-day information is separated by the reproduction determining circuit 19 from the input packet and, at step S29, current time-of-day information is obtained from the time-of-day information managing circuit 16.

After this, at step S30, by the reproduction determining circuit 19, the time-of-day information separated from the packet is compared with current time-of-day information and the elapsed time to the present time from the point of time at which the contents are recorded on the hard disk 18a is calculated and, at step S31, it is determined whether or not the elapsed time exceeds the viewing restriction time.

If the elapsed time exceeds the viewing restriction time (YES), the packet read out from the hard disk 18a is discarded by the reproduction determining circuit 19 at step S32. If, on the other hand, the elapsed time is within the viewing restriction time (NO), the packet is extracted by the reproduction determining circuit 19 into the TS demultiplexer 13 at step S33 for reproduction.

After step S32 or S33, it is determined by the reproduction determining circuit 19 at step S34 whether or not the reproduction of all packets constituting those contents to be reproduced is completed. If NO, control goes back to step S27 and, if YES, reproduction completion processing is carried out at step S35 and control is ended at step S36.

According to the above-mentioned embodiment, the time-of-day information attached to the contents at a time of recording onto the hard disk 18a and time-of-day information at a time of effecting the time shift reproduction are generated at the time-of-day information managing circuit 16 in the digital broadcast recording/reproducing apparatus. And, even if the time-of-day information on the air cannot be correctly obtained due to poor reception, etc., it is possible to set a correct viewing restriction to the time shift reproduction.

Further, in the case where a power source voltage supplied to the time-of-day managing circuit 16 is detected as having been lower than a predetermined level, it is determined that the time-of-day information managing circuit 16 was not able to perform a normal operation and, without the use of generated time-of-day information, the time shift reproduction of the contents is not permitted. This eliminates the inconvenience such that, even if the viewing restriction time of permitting the time shift reproduction has been passed, the contents can be reproduced. It is, therefore, possible to perform control on an “as close to the viewing restriction time as possible” basis.

What is claimed is:

1. A digital broadcast recording/reproducing apparatus comprising:
a receiving section configured to receive a digital broadcast and obtain its contents;
a time information managing section driven by being supplied with a power source output and configured to generate time information;
a recording section configured to record the contents which are obtained by the receiving section onto a recording medium, the contents being recorded with the time information attached thereto; and
a reproduction determining section configured to determine, based on the time information attached to the contents read out from the recording medium and the time information generated from the time information managing section, whether or not reproduction of the contents read out from the recording medium is permitted.

2. A digital broadcast recording/reproducing apparatus according to claim 1, wherein the reproduction determining section comprises a detecting section configured to detect whether or not the power source output supplied to the time information managing section has deviated from a normal range and a control section configured to effect control under which the reproduction of the contents readout from the recording medium is not permitted in a state in which the power supply output supplied to the time information managing section is detected by the detecting section as having deviated from the normal range.

3. A digital broadcast recording/reproducing apparatus according to claim 1, wherein the reproduction determining section comprises a calculating section configured to calculate an elapsed time from a time at which the contents obtained at the receiving section are stored in the recording medium to a time at which the contents are read out, the calculation being made based on the time information attached to the contents read out from the recording medium and the time information generated from the time information managing section and a determining section configured to determine whether or not the elapsed time calculated by the calculating section exceeds an initially set restriction time.

4. A digital broadcast recording/reproducing apparatus according to claim 3, wherein the restriction time is set to be within a PAUSE-able time permitted to the contents recorded on the recording medium or within a PAUSE-able time permitted to the contents by being set as a setting specification of the digital broadcast recording/reproducing apparatus.

5. A digital broadcast recording/reproducing apparatus according to claim 3, wherein the reproduction determining section comprises a detecting section configured to detect whether or not the power source output supplied to the time information managing section has deviated from a normal range and a control section configured to effect control under which reproduction of the contents read out from the recording medium is not permitted when the power source output supplied to the time information managing section is detected by the detecting section as having deviated from the normal range and the restriction time is in a finite state.

6. A digital broadcast recording/reproducing apparatus according to claim 5, further comprising a back-up section configured to retain the power source output supplied to the time information managing section within the normal range during over the restriction time.

7. A digital broadcast recording/reproducing apparatus comprising:
a receiving means for receiving a digital broadcast and obtain its contents;
a time information managing means for driving by being supplied with a power source output and for generating time information;
a recording means for recording the contents which are obtained by the receiving means onto a recording medium, the contents being recorded with the time information attached thereto; and
a reproduction determining means for determining, based on the time information attached to the contents read out from the recording medium and the time information generated from the time information managing means, whether or not reproduction of the contents read out from the recording medium is permitted.

8. A digital broadcast recording/reproducing method comprising:
receiving a digital broadcast and obtaining its contents;
generating time information by being supplied with a power source output;
recording the obtained contents onto a recording medium, the contents being recorded with the generated time information attached thereto; and,
based on the time information attached to the contents read out from the recording medium and the generated time information, determining whether or not reproduction of the contents read out from the recording medium is permitted.

9. A digital broadcast recording/reproducing method according to claim 8, wherein the determining comprises detecting whether or not the power source output used in the generation of the time information has deviated from a normal range and effecting control under which reproduction of the contents read out from the recording medium is not permitted in a state in which the power supply output used in the generation of the time information is detected as having deviated from the normal range.

10. A digital broadcast recording/reproducing method according to claim 8, wherein the determining comprises calculating an elapsed time from a time at which the received contents are recorded to a time at which the recorded contents are read out, the calculation being made based on the time information attached to the contents read out from the recording medium and the generated time information, and determining whether or not the calculated elapsed time exceeds an initially set restriction time.

11. A digital broadcast recording/reproducing method according to claim 10, wherein said restriction time is set to be within a PAUSE-able time permitted to contents recorded on the recording medium or within a PAUSE-able time to the contents by being set as a setting specification of a digital broadcast recording/reproducing apparatus.

12. A digital broadcast recording/reproducing method according to claim 10, wherein said determining comprises detecting whether or not the power source output used in the generation of the time information has deviated from a normal range and effecting control under which reproduction of the contents read out from the recording medium is not permitted when the power source output used in the generation of the time information is detected as having deviated from the normal range and the restriction time is in a finite state.

13. A digital broadcast recording/reproducing method according to claim 12, further comprising retaining the power source output used in the generation of the time information within the normal range over the restriction time.
